(19) United States
(12) Patent Application Publication
(10) Pub. No.: US 2016/0082948 A1
(43) Pub. Date: Mar. 24, 2016

(54) TRANSMISSION CONTROL METHOD DURING REGENERATIVE BRAKING OF HYBRID VEHICLE

(71) Applicants: Hyundai Motor Company, Seoul (KR); Kia Motors Corporation, Seoul (KR)

(72) Inventors: Sang Joon KIM, Seoul (KR); Young Chul KIM, Seoul (KR); Joon Young PARK, Seoul (KR); Kyu Hwan JO, Seoul (KR); Chan Ho Lee, Seoul (KR); Sung Deok KIM, Hwaseong-si (KR)

(73) Assignees: Hyundai Motor Company, Seoul (KR); Kia Motors Corporation, Seoul (KR)

(21) Appl. No.: 14/570,696

(22) Filed: Dec. 15, 2014

(30) Foreign Application Priority Data
Sep. 24, 2014 (KR) 10-2014-0127504

(51) Int. Cl. B60W 20/00; B60W 30/18; B60K 6/36

(52) U.S. Cl. CPC B60W 20/1062; B60K 6/36; B60W 30/18127; Y10S 903/945

(57) ABSTRACT

A transmission control method during regenerative braking of a hybrid vehicle is directed to providing a transmission control method during regenerative braking of a hybrid vehicle that is capable of accurately estimating the regenerative braking execution amount, by constantly controlling the transmission output torque, that is, the regenerative braking execution amount, until the transmission input speed reaches the speed corresponding to the target transmission stage, through the operating element torque and motor torque intervention control for transmission, when transitioning to the target transmission stage from the current transmission stage of the multistage automatic transmission of the hybrid vehicle, and is capable of accurately estimating the regenerative braking execution amount and simultaneously securing the braking linearity during transmission.

### CROSS-REFERENCE TO RELATED APPLICATION

The present application claims priority to Korean Patent Application No. 10-2014-0127504 filed on Sep. 24, 2014, the entire contents of which is incorporated herein for all purposes by this reference.

### BACKGROUND

1. Field of the Invention

The present disclosure relates to a transmission control method during regenerative braking of a hybrid vehicle. More particularly, it relates to a transmission control method during regenerative braking of a hybrid vehicle adapted to be able to secure the braking linearity during transmission.

2. Description of Related Art

As an example, as illustrated in FIG. 1, a power transmission system for a hybrid vehicle is configured to include an engine 10 and a motor 12 arranged in series to each other, an engine clutch 13 that is arranged between the engine 10 and the motor 12 to transfer or disconnect the engine power, an automatic transmission 14 that shifts and outputs the motor or the motor and the engine power to a driving wheel, a HSG 16 (Hybrid Starter Generator) as a kind motor that is connected to a crank pulley of the engine to be able to transfer the power to start up the engine and generate the electricity, an inverter 18 for the motor control and the power generation control, and a high-voltage battery 20 that is connected to the inverter in a chargeable and dischargeable manner to provide the electric power to the motor 12 or the like.

Such a power transmission system for a hybrid vehicle is a type in which the motor is attached to the automatic transmission side, is called a TMED (Transmission Mounted Electric Device) type, and provides traveling modes such as an EV (electric vehicle) mode as a pure electric vehicle mode that uses only the motor power, a HEV (hybrid electric vehicle) mode that uses the motor as an auxiliary power while using the engine as a main power, a regenerative braking (RB) mode that recovers braking and inertial energy of the vehicle during braking of the vehicle or during traveling due to inertia through the power generation in the motor to charge the battery.

Meanwhile, the automatic transmission is a multi-stage transmission, and has a problem in which it is difficult to adjust the braking linearity during transmission, due to inaccuracy of estimation of the regenerative braking execution amount (regenerative braking amount) at the time of regenerative braking

As shown in FIG. 2, if a driver steps on a brake pedal during traveling, a total braking amount is determined, and the total braking amount is distributed into a regenerative braking amount and a braking amount of a friction brake, based on the braking distribution control.

At this time, in order to brake the remainder of the total braking amount by the friction brake, there is a need to accurately estimate the regenerative braking amount, and if estimation of the regenerative braking amount is not accurate, there are problems of an occurrence of braking slip or over-braking

In this case, a conventional method of estimating the regenerative braking amount during transmission will be described below referring to FIG. 3.

Conventionally, for estimation of the regenerative braking amount during transmission, as shown in FIG. 3, a method of predicting the wheel torque (transmission output torque) before and after the transmission start to linearly connect the wheel torque has been used.

However, the conventional estimation of the regenerative braking amount during transmission has advantages that it can be obtained by a simple linear interpolation without considering the transmission mechanism, but it has a problem of an error occurrence between the estimated regenerative braking amount and the actual regenerative braking execution amount, due to a difference between the wheel torques before and after transmission (transmission output torque).

Therefore, in the case of the transmission in which the wheel torque difference before and after transmission is not large, the error is small, and it is possible to maintain the constant braking linearity from the viewpoint of the total braking amount. However, in the case where the wheel torque difference is large before and after the transmission according to the gear ratio of the transmission, there is a problem of effecting the braking linearity such as braking slip or over-braking, due to the great error.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a transmission control method during regenerative braking of a hybrid vehicle that is capable of accurately estimating the regenerative braking amount during transmission, and easily securing the braking linearity at the time of transmission during regenerative braking

In one aspect, the present invention provides a transmission control method during regenerative braking of a hybrid vehicle that may include as a transmission control phase during regenerative braking, a torque control phase of causing a transmission output torque (T_{TM}_{_{—}}ₒᵤₜ) to follow a wheel torque (T_{whl}_{_{—}}_{dmd} (GP=j)) of a current transmission stage, through a torque control and a motor torque intervention control of a coupling side operating element and a release side operating element, an inertia control phase in which by the coupling side operating element, a synchronization control of setting a transmission input speed (rpm) to be a speed corresponding to a target transmission stage is performed and simultaneously the transmission output torque (T_{TM out}) is equally followed to the torque control phase, a transmission completion control phase of interrupting a motor torque intervention control on the current transmission input torque [Tq (Input)] such that the transmission output torque (T_{TM}_{_{—}}_{Out}) transitions to the wheel torque [T_{whl}_{_{—}}_{dmd} (GP=j−1)] of the target transmission stage, and a regenerative braking amount estimation phase of estimating the regenerative braking amount, during the torque control phase, the inertia control phase, and the transmission completion control phase.

Through the means for solving the problems as described above, the present invention provides the same effects as follows.

The present invention is able to accurately estimate the regenerative braking execution amount, by constantly controlling the transmission output torque, that is, the regenerative braking execution amount, until the transmission input speed reaches the speed corresponding to the target transmission stage, through the operating element torque and motor torque intervention control for transmission, when transitioning to the target transmission stage from the current transmission stage of the multistage automatic transmission of the hybrid vehicle, and is able to accurately estimate the regenerative braking execution amount and simultaneously secure the braking linearity during transmission.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a power transmission system diagram showing a power transmission system for a hybrid vehicle.

FIG. 2 is a schematic diagram showing braking force distribution process of the hybrid vehicle.

FIG. 3 is a control diagram showing a conventional estimation method of the regenerative braking amount during transmission.

FIG. 4 is a configuration diagram of a controller for transmission and regenerative braking of the hybrid vehicle.

FIG. 5A, FIG. 5B and FIG. 5C are control diagrams showing a transmission control method during regenerative braking of a hybrid vehicle according to an exemplary embodiment of the present invention.

FIG. 6 is a flowchart showing the transmission control method during regenerative braking of the hybrid vehicle according to an exemplary embodiment of the present invention.

FIG. 7 is a flowchart showing the estimation method of regenerative braking amount during transmission control of the hybrid vehicle according to an exemplary embodiment of the present invention.

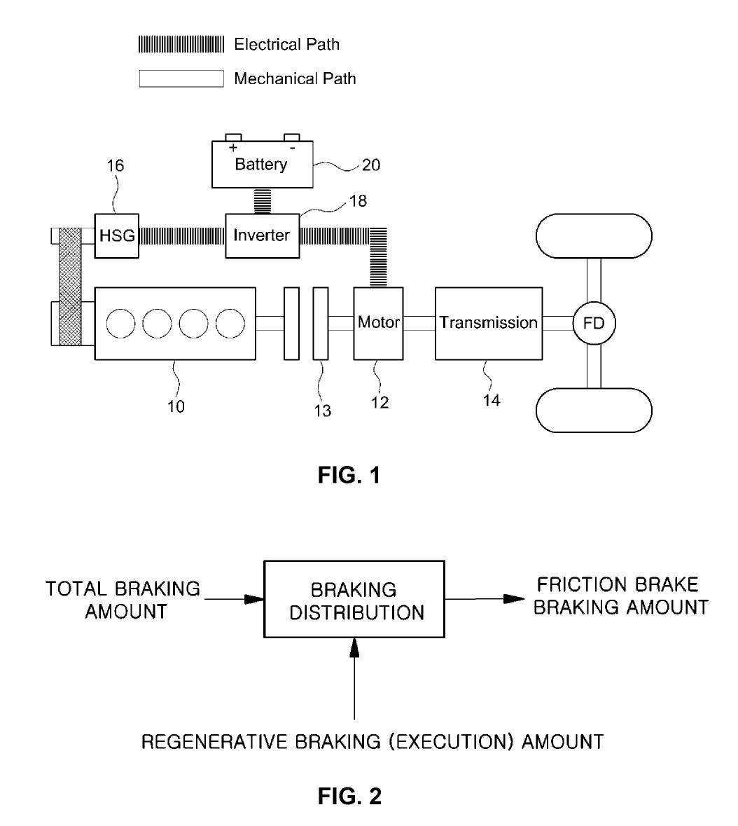

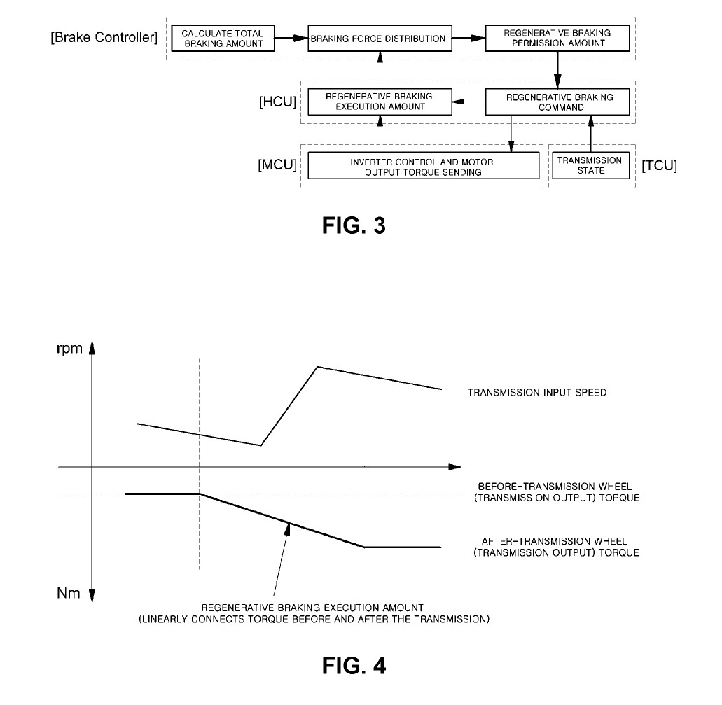

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the invention will be described in detail with reference to the accompanying drawings.

First, a controller configuration for regenerative braking control and transmission control of the hybrid vehicle will be described referring to accompanying FIG. 4 to assist the understanding of the present invention.

Brake Controller: calculates the total braking amount, and performs the distribution control of the braking force of the friction brake while referring to a regenerative braking amount of a vehicle controller (HCU) (execution amount).

Vehicle Controller (HCU): as a top controller, determines the regenerative brake command in consideration of the regenerative braking prohibition situations or the like, estimates the regenerative braking amount in consideration of the motor and the transmission state, sends the regenerative braking amount to the brake controller, and simultaneously commands the regenerative braking command to the motor.

Motor Controller (MCU): performs the motor control for the regenerative braking in accordance to the regenerative braking command of the vehicle controller.

Transmission Controller (TCU): performs a multi-stage transmission control of an automatic transmission (multi-stage transmission) and sends the current transmission state as a factor for estimating the regenerative braking amount to the vehicle controller.

The present invention puts the emphasis on the fact that the transmission control is performed to facilitate the estimation of regenerative braking execution amount, based on the control operation of the above-described controller, thereby being able to accurately estimate the regenerative braking execution amount and to secure the braking linearity during transmission.

Here, the regenerative braking control method during transmission of a hybrid vehicle according to an exemplary embodiment of the present invention will be described in detail.

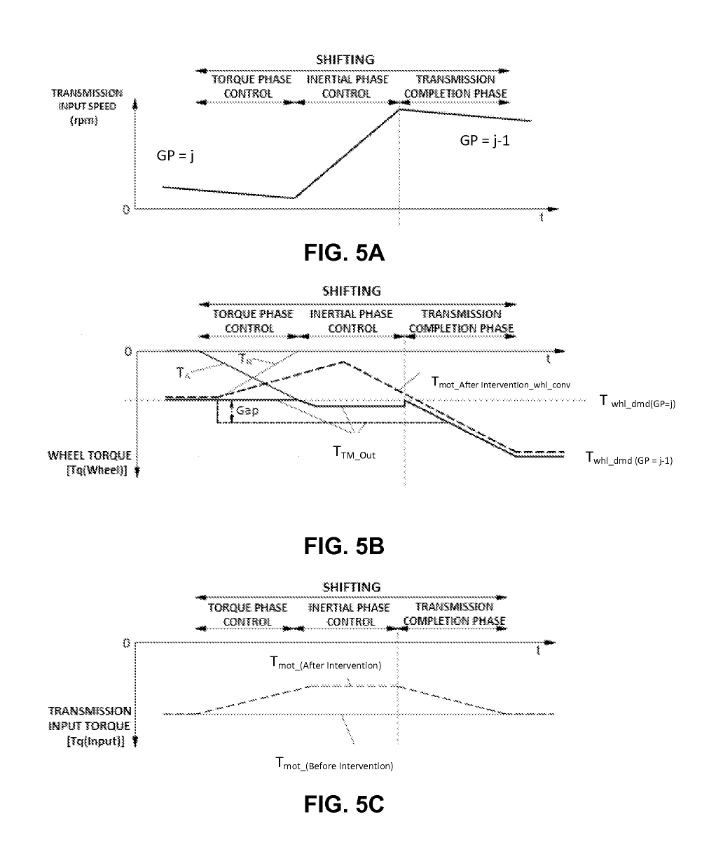

Accompanying FIG. 5A, FIG. 5B and FIG. 5C are control diagrams showing the regenerative braking control method during transmission of the hybrid vehicle according to an exemplary embodiment of the present invention.

In order to assist understanding of the present invention, the meanings of abbreviations and terms indicated in FIG. 5A, FIG. 5B and FIG. 5C will be organized as follows:

GP: gear Position

j: current transmission stage

j−1: target transmission stage

T_{whl}_{_{—}}_{dmd} (GP=j): wheel torque of current transmission stage

T_{whl}_{_{—}}_{dmd} (GP=j−1): wheel torque of target transmission stage

T_{TM}_{_{—}}_{Out}: transmission output torque=regenerative braking torque

T_{A}: Torque of coupling (APPLY) side operating element

T_{R}: Torque of release side operating element

Tₘₒₜ_{_{—}}_{(Before Intervention)}: required motor torque (=transmission input torque)

Tₘₒₜ_{_{—}}_{(After Intervention)}: motor torque increased for transmission control (=transmission input torque)

Tₘₒₜ_{_{—}}_{AfterIntervention}_{_{—}}_{Whl}_{_{—}}_{Conv}=Tₘₒₜ_{_{—}}_{(AfterIntervention)}×transmission input speed/transmission output speed

Gap: shows the transmission output torque, when increasing a torque (T_{A}, negative torque) range of the coupling side operating element to prevent the transmission input speed slackening at an inertia phase during transmission.

Meanwhile, the automatic transmission of a hybrid vehicle is equipped with several frictional elements such as a clutch and a brake, and a multi-stage transmission is achieved by hydraulically controlling the operation of these elements.

At this time, the coupling side operating element and the release side operating element are clutches of the automatic transmission, and as a clutch actuator for coupling and releasing the clutch, a hydraulic pressure control solenoid valve or a motor-driven type actuator is used.

The regenerative braking amount (=regenerative braking execution amount) refers to transmission output torque coming out of the transmission output. In a situation where the transmission does not occur, it can be calculated as “transmission input torque x gear ratio x efficiency”, but it may vary depending on the transmission operating element control strategy of the transmission, during transmission.

In view of the fact that the regenerative braking execution amount can vary depending on the transmission operating element control strategy of the automatic transmission, the present invention is characterized in that, at the time of transition from the before-transmission transmission stage (the current transmission stage) to the after-transmission transmission stage (target transmission stage) of the multi-stage automatic transmission, by controlling the operating element (for example, a clutch) torque for transmission, until the transmission input speed reaches the speed corresponding to the target transmission stage, the transmission output torque, i.e., the regenerative braking execution amount is constantly controlled, thereby being able to accurately estimate the regenerative braking execution amount, and in that it is possible to accurately estimate the regenerative braking execution amount and to ensure the braking linearity during transmission.

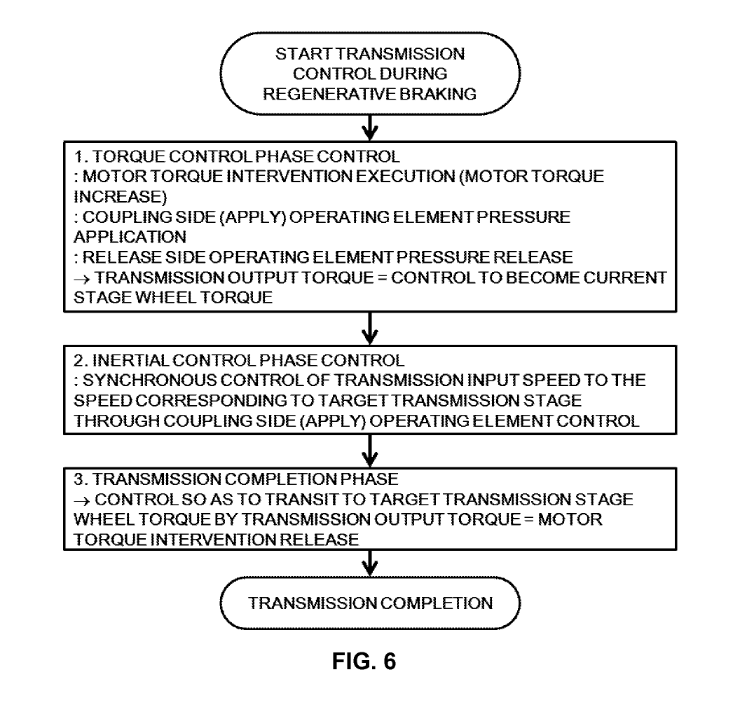

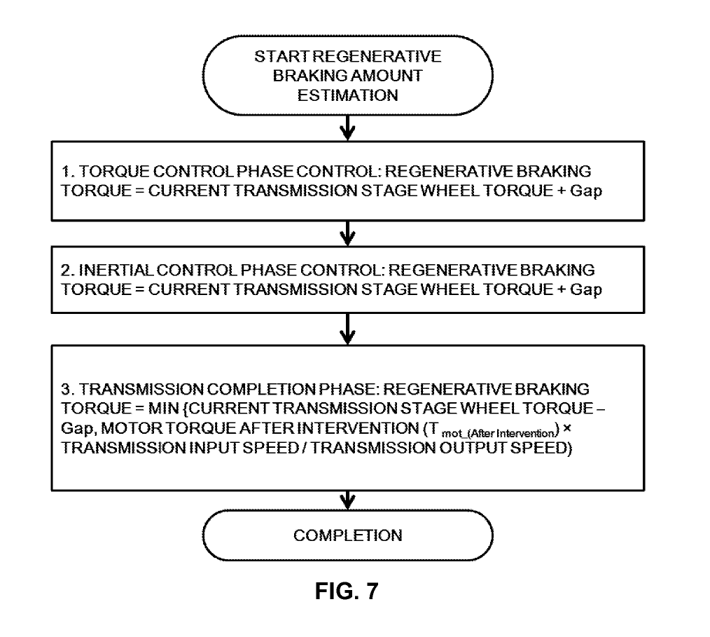

To this end, as in the flowchart of FIG. 6, the transmission control of the automatic transmission from the current transmission stage to the target transmission stage dividedly proceeds into a torque control phase, an inertia control phase, and a transmission completion control phase, and the regenerative braking amount estimation phase proceeds as in the flowchart of FIG. 7 for each phase.

### (i) Torque Control Phase

In the above-described torque control phase, the control is performed in which the hydraulic pressure to the coupling side operating element is applied and the hydraulic pressure to the release side operating element is released, and the motor torque intervention control is performed.

Thus, as shown in FIG. 5B, the torque (T_{R}, negative torque) due to the release side operating elements gradually increases so as to become zero (0) until the inertial control phase is started so that the transmission output torque (T_{TM}_{_{—}}_{Out}), that is, the regenerative braking execution amount (regenerative braking torque) has a constant linearity, and at the same time, the torque (T_{A}, negative torque) due to the coupling side operating element gradually decreases until the inertia control phase is started in proportion to an amount of increase of the torque (T_{R}) due to the release side operating element.

At the same time, the current transmission input torque [Tq (Input)] increases until the inertia control phase is finished, through the motor torque intervention control, that is, a control of artificially increasing the negative motor torque value during regenerative braking

That is, as shown in FIG. 5C, the transmission input torque [Tq (Input)] is controlled to become a motor torque (Tₘₒₜ_{_{—}}_{(After Intervention)}) increased for transmission control in a motor request torque (Tₘₒₜ_{_{—}}_{(Before Intervention)}) before the motor intervention until the inertia control phase is finished from the torque control phase.

As described above, by performing the control that increases the torque (T_{R}, negative torque) due to the release side operating element and simultaneously decreases the torque (T_{A}, negative torque) due to the coupling operating element, and the motor torque intervention control of increasing the transmission input torque to become the motor torque (Tₘₒₜ_{_{—}}_{(After Intervention)} increased for transmission control at the torque control phase, the transmission output torque (T_{TM}_{_{—}}_{Out}) during transmission, that is, the regenerative braking execution amount (regenerative braking torque) has a constant linearity, and the transmission output torque (T_{TM}_{_{—}}_{Out}) having such a constant linearity follows the wheel torque of the current transmission stage (T_{whl}_{_{—}}_{dmd} (GP=j)).

### (ii) Inertia Control Phase

In the above-described inertia control phase, the synchronization control is performed such that the transmission input speed (rpm) becomes the speed corresponding to the target transmission stage, and simultaneously, the transmission output torque (T_{TM}_{_{—}}_{Out}) is controlled to continuously follow the wheel torque (T_{whl}_{_{—}}_{dmd} (GP=j)) of the current transmission stage, while having the constant linearity as described in the above torque control phase.

At this time, when the transmission input speed during transmission gradually increases according to the speed of the target transmission stage from the start to the end of the inertia control phase, the transmission output torque (T_{TM}_{_{—}}_{Out}) estimating the wheel torque (T_{whl}_{_{—}}_{dmd} (GP=j)) of the current transmission stage maintains the constant linearity, and can be controlled to a level that is slightly higher than the torque control phase.

(iii) Transmission Completion Control Phase

When the above-mentioned inertia control phase is finished, the motor torque intervention control of the current transmission input torque [Tq (Input)] is interrupted.

That is, the motor torque intervention control of artificially increasing the negative motor torque value during regenerative braking is interrupted such that the transmission input torque [Tq (Input)] is returned to the motor request torque (Tₘₒₜ_{_{—}}_{(Before Intervention)} before the motor intervention.

At this time, the transmission output torque (T_{TM Out}) is controlled to transition to the wheel torque [T_{whl}_{_{—}}_{dmd} (GP=j−1)] of the target transmission stage by the motor torque intervention release. In this way, by controlling the transmission output torque to have the constant linearity so as to follow the wheel torque of the current transmission stage until the transmission input speed reaches the speed corresponding to the target transmission stage through the operating element (for example, a clutch) torque and the motor torque intervention control for transmission during the transmission of the automatic transmission, it is possible to secure the braking linearity during transmission, thereby being able to prevent a phenomenon in which a braking performance is degraded due to a great difference in wheel torque before and after the transmission (braking slip or over-braking or the like).

Meanwhile, the phase of accurately estimating the regenerative braking execution amount at the time of regenerative braking during the transmission proceeds as described above.

### (v) Regenerative Braking Amount Estimation Phase

The regenerative braking amount estimation phase proceeds by the torque control phase, the inertia control phase, and the transmission complete control phase.

At this time, a symbol “Gap” indicated in FIG. 5B shows the transmission output torque (T_{TM}_{_{—}}_{Out}) in the case of expanding the torque (T_{A}, negative torque) range of the coupling side operating element so as to prevent the transmission input speed slackening at the inertia phase during transmission within the wheel torque [T_{whl}_{_{—}}_{dmd} (GP=j)] of the current transmission stage and the wheel torque [T_{whl}_{_{—}}_{dmd} (GP=j−1)] of the target transmission stage.

Also, the symbol “Gap” can be expressed by the following formula 1.

Gap=(T_{whl}_{_{—}}_{dmd}(GP=j)−T_{whl}_{_{—}}_{dmd}(GP=j−1))×Gain (phase, class) [Formula 1]

In the above formula 1, T_{whl}_{_{—}}_{dmd} (GP=j): a wheel torque of the current transmission stage, T_{whl}_{_{—}}_{dmd} (GP=j−1): a wheel torque of the target transmission stage, the Phase in the gain indicates the torque control phase, the inertia control phase, and the transmission completion control phase during the transmission, and Class in the gain indicates the transmission type (e.g., one of various transmissions of transmission from the current transmission stage to the target transmission stage, such as third speed fourth speed, fifth speed→sixth speed, etc.)

Thus, when estimating the above-described regenerative braking amount (=regenerative braking execution amount=regenerative braking torque), when the above-described “Gap” is present, there is a need to include the “Gap”.

Therefore, at the torque control phase and the inertia control stage during transmission described above, when there is no “Gap”, the transmission output torque (T_{TM}_{_{—}}_{Out}) with constant linearity, that is, the regenerative braking amount (=regenerative braking execution amount=regenerative braking torque) is estimated to the wheel torque (T_{whl}_{_{—}}_{dmd} (GP=j)) of the current transmission stage, and when the “Gap” is present, it is estimated to a value obtained by adding “Gap” to the wheel torque (T_{whl}_{_{—}}_{dmd} (GP=j)) of the current transmission stage.

Furthermore, at the transmission completion control phase, the transmission output torque (T_{TM}_{_{—}}_{Out}) with the negative output torque value, that is, the regenerative braking amount (=regenerative braking execution amount=regenerative braking torque) is controlled to transition to the wheel torque [T_{whl}_{_{—}}_{dmd} (GP=j−1)] of the target transmission stage by the motor torque intervention release, but when the “Gap” is present, it can be estimated by the following formula 2.

Regenerative braking torque=transmission output torque (T_{TM}_{_{—}}_{Out})=min [{T_{whl}_{_{—}}_{dmd} (GP=j) Gap}, {Tₘₒₜ_{_{—}}_{After Intervention}_{_{—}}_{whl}_{_{—}}_{conv}=Tₘₒₜ_{_{—}}_{(After Intervention)×transmission input speed/transmission output speed}]} [Formula 2]

In the above Formula 2, T_{whl}_{_{—}}_{dmd} (GP=j): wheel torque of the current transmission stage, Tₘₒₜ_{_{—}}_{(After Intervention)}: motor torque increased for the transmission control (=transmission input torque), Tₘₒₜ_{_{—}}_{After Intervention}_{_{—}}_{Whl}_{_{—}}_{Conv}=Tₘₒₜ_{_{—}}_{(After Intervention)}×the transmission input speed/transmission output speed, respectively.

Therefore, between the torque value obtained by subtracting “Gap” from the wheel torque of the current transmission stage [T_{whl}_{_{—}}_{dmd} (GP=j)] and the Tₘₒₜ_{_{—}}_{After Intervention}_{_{—}}_{Whl}_{_{—}}_{Conv}(Tₘₒₜ_{_{—}}_{(After Intervention)}×transmission input speed/transmission output speed) value, the minimum value can be estimated to regenerative braking amount (=regenerative braking execution amount =regenerative braking torque).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transmission control method during regenerative braking of a hybrid vehicle comprising:
a transmission control phase during regenerative braking;
a torque control phase of causing a transmission output torque (T_{TM}_{_{—}}_{Out}) to follow a wheel torque (T_{whl}_{_{—}}_{dmd} (GP=j)) of a current transmission stage, through a torque control and a motor torque intervention control of a coupling side operating element and a release side operating element;
an inertia control phase in which a synchronization control of setting a transmission input speed (rpm) to be a speed corresponding to a target transmission stage is performed and simultaneously a transmission output torque (T_{TM}_{_{—}}ₒᵤₜ) is equally followed to the torque control phase;
a transmission completion control phase of interrupting a motor torque intervention control on a current transmission input torque [Tq (Input)] such that the transmission output torque (T_{TM}_{_{—}}_{Out}) transitions to the wheel torque [T_{whl}_{_{—}}_{dmd} (GP=j−1)] of the target transmission stage; and
a regenerative braking amount estimation phase of estimating the regenerative braking amount, during the torque control phase, the inertia control phase, and the transmission completion control phase.

2. The method of claim 1, wherein the torque control phase includes
a process in which a torque (T_{R}, a negative torque) due to the release side operating element gradually increases to become zero until the inertia control phase is started;
a process in which a torque (T_{A}, a negative torque) due to the coupling side operating element gradually decreases until the inertia control phase is started in proportion to an increase amount of torque (T_{R}) due to the release side operating element; and
a process in which the current transmission input torque [Tq (Input)] increases until the inertia control phase is terminated through the motor torque intervention control.

3. The method of claim 1, wherein in the regenerative braking amount estimation stage,
when there is no “Gap” during the torque control phase and the inertia control phase, the transmission output torque (T_{TM}_{_{—}}_{Out}) which signifies the regenerative braking amount is estimated to the wheel torque (T_{whl}_{_{—}}_{dmd} (GP=j) of the current transmission stage.

4. The method of claim 1, wherein in the regenerative braking amount estimation stage,
when the “Gap” is present during the torque control phase and the inertia control phase, the transmission output torque (T_{TM}_{_{—}}_{Out}) which signifies the regenerative braking amount is estimated to a value obtained by adding “Gap” to the wheel torque (T_{whl}_{_{—}}_{dmd} (GP=j)) of the current transmission stage.

5. The method of claim 1, wherein in the regenerative braking estimation stage, when the “Gap” is present during the transmission completion control stage, the transmission output torque (T_{TM}_{_{—}}_{Out}), which signifies the regenerative braking amount is determined by
Regenerative braking torque=transmission output torque (T_{TM}_{_{—}}_{Out})=min [{T_{whl}_{_{—}}_{dmd} (GP=j)−Gap}, {Tₘₒₜ_{_{—}}_{After Intervention}_{_{—}}_{whl}_{_{—}}_{conv}=Tₘₒₜ_{_{—}}_{(After Intervention)}×transmission input speed/transmission output speed}]
in the above formula, T_{whl}_{_{—}}_{dmd} (GP=j): wheel torque of the current transmission stage, Tₘₒₜ_{_{—}}_{(After}_{_{—}}_{Intervention)}: motor torque increased for the transmission control (=transmission input torque), Tₘₒₜ_{_{—}}_{After Intervention}_{_{—}}_{Whl}_{_{—}}_{Conv}=Tₘₒₜ_{_{—}}_{(After Intervention)}×transmission input speed/transmission output speed, respectively.

6. The method of any one of claims 3 to 5, wherein the Gap is determined by Gap=(T_{whl}_{_{—}}_{dmd} (GP=j)−T_{whl}_{_{—}}_{dmd} (GP=j−1))×Gain (phase, class),
in the above formula, T_{whl}_{_{—}}_{dmd} (GP=j): wheel torque of the current transmission stage, T_{whl}_{_{—}}_{dmd} (GP=j−1): wheel torque of the target transmission stage, the Phase in the gain indicates one of the torque control phase, the inertia control phase, and the transmission completion control phase, and the Class indicates the transmission type.

7. The method of claim 1, wherein, when the transmission input speed during transmission gradually increases according to the speed of the target transmission stage from start to end of the inertia control phase, the transmission output torque (T_{TM}_{_{—}}_{Out}) maintains constant linearity, and is controlled to a level that slightly increases compared to the torque control stage.
